(19) United States
(12) Patent Application Publication
(10) Pub. No.: US 2007/0159702 A1
(43) Pub. Date: Jul. 12, 2007

(54) Pickup unit and disk drive unit provided with such a pickup unit

(75) Inventors: Andre Latenstein Van Voorst, Eindhoven (NL); Jan Michiel Gustaaf Renckens, Hechtel-Eksel (BE); Johannes Antonius Van Rooij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,096

(22) PCT Filed: Oct. 25, 2004
(86) PCT No.: PCT/IB04/52197

§ 371 Date: Apr. 25, 2006

(30) Foreign Application Priority Data
Oct. 30, 2003 (EP) 03104027.2

(51) Int. Cl. G02B 7/02

(52) U.S. Cl. 359/813

(57) ABSTRACT

The invention relates to a pickup unit (1) for reading and/or writing data on a disk (2). The pickup unit (1) comprises a lens (5) in a lens holder (6) which is connected to a frame (7) of the pickup unit (1) by a plurality of elastic support members (8). The lens holder (6) is movable with respect to the disk (2) by bending of the elastic support members (8). The mounting position (9) of each elastic support member (8) at the lens holder (6) is located closer to the disk (2) than the respective mounting position (10) of the elastic support member (8) at the frame (7), as seen in the focusing direction of the lens (5). In this manner the lens holder (6) with the lens (5) is adapted to be brought to an operating distance with respect to the disk (2) which is smaller than the flatness tolerances of the disk (2) without the risk of collisions between the frame (7) and the rotating disk (2).

FIELD OF THE INVENTION

The invention relates to a pick up unit for reading and/or writing data on a disk.

### BACKGROUND OF THE INVENTION

A pickup unit of this type is known from patent application US 2002/0009032 A1.

US 2002/0009032 A1 discloses a pickup unit for recording and reproducing information on and from an optical disk. The pickup unit comprises an objective lens provided in a lens holder which is connected to a frame by two pairs of elastic support members. The elastic support members extend parallel to each other and substantially parallel to the surface of the disk. In order to focus the lens with respect to the disk, the lens holder is movable towards and from the disk in a focus direction of the lens by a deflection of the elastic support members powered by a driving coil and a magnet. The lens and the portion of the frame closest to the surface of the disk both have about the same distance to the surface of the disk. As it is more and more desired to have a very small operating distance between the lens and the surface of the disk - smaller than the flatness tolerances of the disk, a risk of undesired collisions between the pickup unit and the disk exists, in particular between the disk and the portion of the frame closest to the surface of the disk. Collisions between the disk and the pickup unit may lead to serious damage to the surface of the disk.

In an attempt to solve this problem, a pickup unit known in the art comprises a lens holder having a lens mounted thereto by means of a pedestal. In this manner, the lens extends in an elevated position with respect to the frame of the pickup unit. As a result the lens can be positioned at a distance with respect to the surface of the disk which is smaller than the flatness tolerances of the disk, without the risk of collisions between the disk and the portion of the frame closest to the surface of the disk. However, mounting of the relatively heavy lens on the pedestal raised the center of mass of the lens holder with respect to the center of stiffness of the elastic support members accordingly. This leads to unfavorable dynamic properties of the lens holder which must be compensated by a counterweight mounted to the lens holder on the side opposed to the pedestal. Due to the additional mass of the pedestal and the counterweight, however, the movement of the lens holder needs to be powered by more powerful driving coils and magnets.

### SUMMARY OF THE INVENTION

It is an object of the invention to provide an improved pickup unit for reading and/or writing data on a disk.

In order to accomplish that objective, the pickup unit according to the invention comprises a lens in a lens holder which is connected to a frame of the pickup unit by at least one elastic support member extending between a mounting position at the lens holder and a mounting position at the frame, the lens holder being movable with respect to the frame in a focusing direction of the lens towards and away from the disk by bending of the at least one elastic support member under the action of an actuator acting between the lens holder and the frame, wherein at least in an inactivated state of the actuator the mounting position of the at least one elastic support member at the lens holder is located closer to the disk than the respective mounting position of the at least one elastic support member at the frame, as seen in the focusing direction of the lens.

In the pickup unit according to the invention, it is possible to position the lens closer to the disk than the frame of the pickup unit without the need to use a counterweight. This is a result of the fact that in the invention not only the center of mass of the lens holder is raised but also the center of stiffness of the at least one elastic support member. Consequently it is not necessary to lower the center of mass of the lens holder again to coincide with the center of stiffness.

Due to the features as defined in claim 2 the desired effect can be obtained by a simple, substantially rectilinear support member.

Other embodiments of the pickup unit according to the invention are described in the claims 3 to 8.

The invention also relates to a disk drive unit comprising a disk drive and the pickup unit according to the invention.

Aspects and advantages of the invention will be apparent from the following description which is given with reference to the drawings.

### BRIEF DESCRIPTION OF THE DRAWINGS

FIG. 1 is a perspective top view of a portion of a disk drive unit provided with a preferred embodiment of the pickup unit according to the invention;

FIG. 2 is a side view of the pickup unit shown in FIG. 1, with some parts removed for clarity.

### DESCRIPTION OF THE PREFERRED EMBODIMENT

The drawings show a preferred embodiment of the pickup unit according to the invention. This pickup unit 1 may be used in a device for reading and/or writing data on a disk, such as a compact disk player, which is adapted to read/and or write compact disks for audio and/or video by means of an optical or magnetic reading and/or writing member.

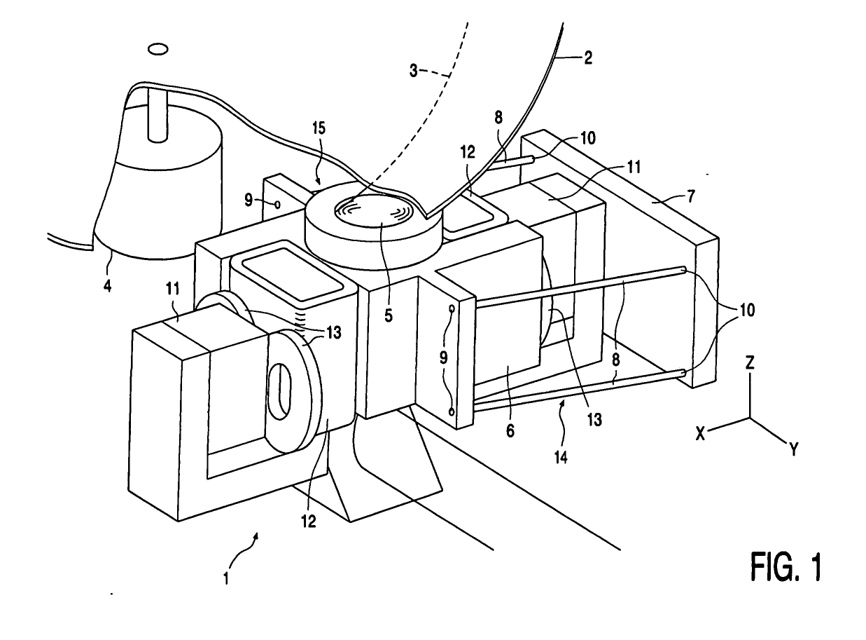

In a disk 2 for use in the previously described disk drive unit, data is encoded in one or more layers of the disk 2, shown schematically in FIG. 1. Various principles are known, each variant being suitable for use in conjunction with the invention. The data is laid down in one or more data tracks 3 in digital form. The variations of (optical) properties along the data tracks contain the data recorded on the disk 2. To read and/or write the data on the disk 2, the latter is rotated by means of a disk drive in the form of a motor 4. The disk 2 is read and/or written by detection of the variations of (optical) properties along the data tracks 3 by the pickup unit 1. In the embodiment shown in FIG. 1, the variations are detected by means of laser light emitted from and reflected back to the pickup unit 1.

With reference to FIG. 1, the preferred embodiment of the pickup unit 1 comprises a lens 5 mounted to a lens holder 6. The lens holder 6 is connected to a frame 7 of the pickup unit 1 by means of four rectilinear wire members 8 (only three are visible in FIG. 1) which are made of a resilient, preferably electrically conductive material, such as copper, iron, or an alloy. In this manner the wire members 8 form elastic support members for suspending the lens holder 6 in a steady (pretensioned) position when no external force is exerted on the lens holder 6, and allowing the lens holder 6 to be slightly moved with respect to the frame 7 when a force is applied to the lens holder 6. The wire members 8 are mounted to the lens holder 6 and the frame 7 in mounting positions 9, 10 at the lens holder 6 and at the frame 7, respectively.

The pickup unit 1 as a whole is movable in a tracking direction y with respect to the disk 2 by means of a slide mechanism (not shown). Under the action of an actuator 11, 12, 13 provided between the lens holder 6 and the frame 7, the lens 5 of the pickup unit 1 is movable with respect to the disk 2 and the frame 7 in the tracking direction y and a focusing direction z, and tiltable in a tangential direction x.

In the preferred embodiment of the pickup unit 1, the actuator 11, 12, 13 comprises a plurality of permanent magnets 11 connected to the frame 7 and a plurality of coils 12, 13 provided at the lens holder 6 and the permanent magnets 11 respectively, such that the coils 12, 13 and the permanent magnets 11 exert forces on the lens holder 6 by means of electric currents through the coils 12, 13. The movement of the lens holder 6 with respect to the frame 7 and the disk 2 is used to focus the laser light on the exact point on the data track 3 in the disk 2 and to position the lens holder 6 in such a way with respect to the disk 2 that the laser light is always locally perpendicular to the surface of the disk 2, despite an inclination of the surface of the disk 2 caused by deviations in the flatness of the surface of the disk 2.

The electric currents through the coils 12, 13 are provided by a control circuit (not shown) for an accurate control of the position and orientation of the lens holder 6 of the preferred embodiment of the pickup unit 1. In order to determine the actual position of the lens holder 6 with respect to the disk 2, the control circuit may use, for example, intensity parameters of the laser light received by the pickup unit 1. The control unit is not considered part of the invention, and a multitude of possible implementations of a control circuit for this purpose are known, so that no further description is given of the control unit.

With reference to FIG. 1, the wire members 8 are provided in two cooperating pairs 14, 15, which the cooperating pairs 14, 15 are positioned at a distance from each other, symmetrically with respect to a plane extending through the center of the lens 5 in the focusing direction z and the tangential direction x. In each cooperating pair 14, 15 of wire members 8, their mounting positions 9 at the lens holder 6 are symmetrically spaced apart in the focusing direction z of the lens 5 with respect to the center of mass of the lens holder 6 for reasons explained in more detail further below in this description. The mounting positions 10 of each cooperating pair of wire members 8 at the frame 7 are spaced apart in the same direction and over the same distance as their respective mounting positions 9 at the lens holder 6. The wire members 8 are mounted such that, in an inactivated state of the actuator 11, 12, 13, the mounting position 9 of each wire member 8 at the lens holder 6 is located closer to the disk 2 than the respective mounting position 10 of the wire member 8 at the frame 7, as seen in the focusing direction z of the lens 5. As a result, the wire members 8 have an inclined position with respect to the plane through the disk 2.

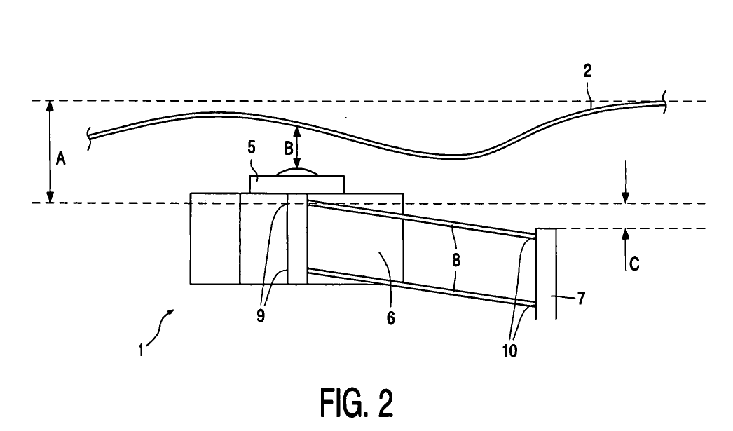

FIG. 2 shows the position of the pickup unit 1 with respect to the disk 2 in a side view of the pickup unit 1. In the drawing, arrow A indicates a possible reach of the disk 2 due to its flatness tolerances, arrow B indicates an operating distance of the lens with respect to the disk 2, and arrow C indicates a required clearance between the frame 7 and the possible reach of the disk 2. For clarity reasons the possible reach of the disk 2 is also indicated by two horizontal dashed lines. As can be seen in the drawing, the lens holder 6 carrying the lens 5 is adapted to be positioned at a very small operating distance with respect to the surface of the disk 2, typically 150 μm to 1 mm, while the whole frame 7 of the pickup unit 1 remains out of reach of the rotating disk 2 owing to the clearance indicated with arrow C that remains between the frame 7 and the possible reach of the rotating disk 2. This clearance may typically be between 1 to 5 mm. It will therefore be understood that collisions between the rotating disk 2 and the frame 7 of the pickup unit 1 are avoided thanks to the raised position of the lens holder 6 with respect to the frame 7, while the lens 5 operates at a very short operating distance B with respect to the disk 2.

In FIG. 1, the four wire members 8 of the pickup unit 1 are formed such that they all have the same length and the same bending stiffness. As a first result, rotations of the lens holder 6 about the focusing direction z and the tracking direction y are avoided when a translating force is exerted on the lens holder 6 in the tracking direction y and the focusing direction z, respectively. As a second result, the center of stiffness of the wire members 8 with respect to the translating movement in the tracking direction y and the focusing direction z of the lens holder 6 is located in the common center of the four mounting positions 9 of the wire members 8 at the lens holder 6. That is, a force exerted on the lens holder 6 at the center of stiffness of the wire members 8 in the focusing direction z or the tracking direction y does not lead to rotations of the lens holder 6 about the tangential direction x. Moreover, the center of stiffness of the wire members 8 is for any steady (pretensioned) position of the lens holder 6 located in the common middle of the mounting positions 9 of the wire members 8 at the lens holder 6. In other words, if the steady (prebiassed) position of the lens holder 6 is moved, the center of stiffness of the wire members 8 is moved accordingly. The lens holder 6 including the lens 5 is dimensioned such that its center of mass coincides with the center of stiffness of the wire members 8. This is why in this embodiment for each cooperating pair 14, 15 the mounting positions 9 of the wire members 8 at the lens holder 6 are symmetrically spaced apart in the focusing direction z of the lens with respect to the center of mass of the lens holder 6. Since the center of mass and center of stiffness coincide, translations of the lens holder 6 in the tracking direction y and the focusing direction z do not lead to unfavourable rotations about the focusing direction z and the tracking direction y, respectively, owing to mass inertia forces, which rotations may typically occur at translating frequencies higher than the natural frequency of the suspended lens holder 6. As for dynamic reasons the prior art lens holders are generally already designed such that their center of mass is located at the common middle of the four mounting positions of the wire members, a prior art lens holder may advantageously be used in the pickup unit 1 according to the invention.

With reference to FIG. 1, the coils 12, 13 and magnets 11 of the actuator 11, 12, 13 are provided in a symmetrical manner in the tangential direction x on both opposite sides of the lens holder 6, wherein the opposite sets of coils 12 for powering the translating movement in the focusing direction z and the opposite coils 13 for powering the translating movement in the tracking direction y and the rotation about the tangential direction x are powered symmetrically by the control unit. As a result, the translating forces and the rotating torques exerted on the lens holder 6 act in fact in the center of each set of coils 12, 13 and magnets 11, whereby this center forms a force center of the actuator 11, 12, 13. In the preferred embodiment, the coils 12, 13 and magnets 11 of the actuator 11, 12, 13 are positioned such that the force center of the actuator coincides with the center of stiffness of the wire members 8 and the center of mass of the lens holder 6. As a result, unfavorable rotations of the lens holder 6 about the tracking direction y and the tangential direction x are avoided when forces in a translating direction are exerted on the lens holder by the actuator 11, 12, 13 at frequencies both higher than and lower than the natural frequency of the suspended lens holder 6, which is also the case with the prior art pick up unit.

It should be understood from the above description that the pickup unit 1 according to the invention comprises a lens 5 which is positioned closer to the disk 2 than its frame 7 in the focusing direction z of the lens, wherein both the center of stiffness of the wire members 8 and the center of mass of the lens holder 6 are positioned closer to the disk 2 by the same distance. As a result, a compensation of the position of the center of mass of the lens holder 6 to avoid unfavorable dynamic properties, for example by means of a counterweight at the lens holder known in the art, is not necessary. Accordingly, more powerful driving coils and magnets for moving such a compensated (heavier) lens holder are not necessary.

The invention is not restricted to the above-described embodiment as shown in the drawings, which may be varied in several ways without departing from the scope of the invention.

For example, the elastic support members may have any kind of shape between their mounting positions, and they may each have a different bending stiffness, as long as the center of stiffness of the wire members coincides with the center of mass of the lens holder. Accordingly, the number of elastic support members is not limited to four, and the pickup unit may thus also be provided, for example, with six elastic support members arranged in two cooperating groups of support members instead of two cooperating pairs of support members.

As a further example, the mounting positions of the elastic support members of each cooperating pair at the lens holder and the frame may be spaced apart by an equal distance and in the same direction, which may be any direction suitable for obtaining the (dynamic) properties of the movement of the lens holder as stated above.

In another variation, the elastic support members may extend at a slight angle with respect to a plane through the lens in the focusing direction and the tangential direction.

Moreover, several combinations of the features defined in the claims are possible.

In general it is noted that, in this application, the expression “comprising” does not exclude other elements, and “a” or “an” does not exclude a plurality. A single processor or unit may fulfill the functions of several elements in the appended claims. Reference signs in the claims shall not be construed as limiting the scope thereof.

1. Pickup unit (1) for reading and/or writing data on a disk (2), comprising a lens (5) in a lens holder (6) which is connected to a frame (7) of the pickup unit (1) by at least one elastic support member (8) extending between a mounting position (9) at the lens holder (6) and a mounting position (10) at the frame (7), the lens holder (6) being movable with respect to the frame (7) in a focusing direction (z) of the lens (5) towards and away from the disk (2) in that the at least one elastic support member (8) is bent under the action of an actuator (11, 12, 13) acting between the lens holder (6) and the frame (7), wherein at least in an inactivated state of the actuator (11, 12, 13) the mounting position (9) of the at least one elastic support member (8) at the lens holder (6) is located closer to the disk (2) than the respective mounting position (10) of the at least one elastic support member (8) at the frame, as seen in the focusing direction (z) of the lens (5).

2. Pickup unit (1) according to claim 1, wherein the at least one elastic support member (8) is substantially rectilinear and has an inclined position with respect to the plane of the disk (2).

3. Pickup unit (1) according to claim 1, comprising a plurality of elastic support members (8), preferably four or six elastic support members (8).

4. Pickup unit (1) according to claim 3, wherein each elastic support member (8) forms part of a cooperating group (14, 15) of elastic support members, and wherein the mounting positions (9, 10) of the elastic support members within the cooperating groups (14 or 15) are spaced apart in the same direction and over an equal distance at the lens holder (6) and at the frame (7).

5. Pickup unit (1) according to claim 3, wherein for each cooperating group (14, 15) of elastic support members (8) their mounting positions (9) at the lens holder (6) are symmetrically spaced apart in the focusing direction (z) of the lens (5) with respect to the center of mass of the lens holder (6).

6. Pickup unit (1) according to claim 3, wherein each elastic support member (8) forms part of a cooperating group (14, 15) of elastic support members (8), and wherein the two cooperating groups (14, 15) of elastic support members (8) are positioned at a distance from each other, symmetrically with respect to a plane extending through the center of the lens (5) in the focusing direction (z) and in a tangential direction (x) of the lens (5) with respect to the disk (2).

7. Pickup unit (1) according to claim 3, wherein the elastic support members (8) are wire members.

8. Pickup unit (1) according to claim 1, wherein the at least one elastic support member (8) is made of an electrically conducting material.

9. Disk drive unit comprising a disk drive and the pickup unit (1) according to claim 1.
